(19) United States
(12) Patent Application Publication
(10) Pub. No.: US 2009/0319407 A1
(43) Pub. Date: Dec. 24, 2009

(54) IMAGE FORMATION APPARATUS, METHOD FOR PROHIBITING THE EXECUTION OF A TARGET JOB, AND A RECORDING MEDIUM THAT STORES A PROGRAM FOR PROHIBITING THE EXECUTION OF A TARGET JOB

(75) Inventors: Kentaro Nagatani, Toyokawa-shi (JP); Tomoko Maruyama, Toyokawa-shi (JP); Akio Nakajima, Toyokawa-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/482,494

(22) Filed: Jun. 11, 2009

(30) Foreign Application Priority Data
Jun. 19, 2008 (JP) 2008-160984

(51) Int. Cl. G06Q 30/00

(52) U.S. Cl. 705/34

(57) ABSTRACT

An image formation apparatus for performing a billing process, by generating billing information of a job after executing the job and transmitting the billing information to a billing apparatus when a connection to the billing apparatus is normal, the image formation apparatus comprising: a storage for storing therein billing information; a judgment part operable to judge whether the connection to the billing apparatus is normal (step S102); and a job execution controller operable to compare a size of billing information of a target job that is targeted for execution with a size of free space of the storage (step S109) in a case where the connection is judged to be a connection failure (No in step S102), and prohibit the execution of the target job (step S112) when the size of the billing information of the target job is larger than the size of the free space of the storage (No in step S109).

### CROSS-REFERENCE TO RELATED APPLICATIONS

This application is based on application No. 2008-160984 filed in Japan, the contents of which are hereby incorporated by reference.

### BACKGROUND OF THE INVENTION

1. Field of the Invention

The present invention relates to an image formation apparatus such as an MFP (Multi Function Peripheral) connected to a billing apparatus, and in particular to an image formation apparatus that stores billing information into a storage device in the case of a connection failure with the billing apparatus.

2. Related Art

An image formation apparatus as described above generates, for each of the jobs such as copying, printing, etc. that has been executed, billing information related to a billing amount of the job. When a connection with a billing apparatus is normal, the image formation apparatus transmits to the billing apparatus the billing information that has been generated.

In the case of a connection failure with the billing apparatus, the image formation apparatus stores the billing information of each job into a storage device, such as an HDD (hard disk drive) in the image formation apparatus. Then, as soon as the connection with the billing apparatus recovers, the image formation apparatus transmits, to the billing apparatus, the billing information that has been stored.

However, in the HDD, the capacity for storing the billing information has been determined in advance. Therefore, when a period of a connection failure gets longer and a large number of jobs to be executed, the size of the billing information to be stored into the HDD may exceed the maximum capacity of the HDD. In this case, although still being able to execute the jobs, the image formation apparatus cannot store the billing information of each of the jobs into the HDD. When the billing information is not stored, the billing apparatus cannot perform a billing process accurately, even if the connection between the image formation apparatus and the billing apparatus recovers.

### SUMMARY OF THE INVENTION

In view of the above-described problem, an aim of the present invention is to provide an image formation apparatus that enables a billing apparatus to accurately perform a billing process, even in the case of a connection failure with the billing apparatus, after the recovery of the connection.

In order to solve the above-described problem, one aspect of the present invention provides an image formation apparatus for performing a billing process, by generating billing information of a job after executing the job and transmitting the billing information to a billing apparatus when a connection to the billing apparatus is normal, the image formation apparatus comprising: a storage for storing therein billing information; a judgment part operable to judge whether the connection to the billing apparatus is normal; and a job execution controller operable to compare a size of billing information of a target job that is targeted for execution with a size of free space of the storage in a case where the connection is judged to be a connection failure, and prohibit the execution of the target job when the size of the billing information of the target job is larger than the size of the free space of the storage.

With the above-described structure, in a case where the connection between the image formation apparatus and the billing apparatus is judged to be a connection failure, if the size of the billing information of the target job is larger than the size of the free space of the storage, the image formation apparatus prohibits the execution of the target job. Therefore, it is possible to prevent a situation where the image formation apparatus cannot store the billing information related to a job, although being able to execute the job. Since the billing information related to a job is securely stored in the case of a connection failure, it is possible for the billing apparatus to perform a billing process accurately after the recovery of the connection.

### BRIEF DESCRIPTION OF DRAWINGS

These and other objects, advantages, and features of the invention will become apparent from the following description thereof taken in conjunction with the accompanying drawings, which illustrate a specific embodiment of the present invention. In the drawings:

FIG. 1 shows a billing system;

FIG. 2 shows a hardware structure of an MFP 100;

FIG. 3 is a block diagram showing a functional structure of the MFP 100;

FIG. 4A shows a data structure of billing information in a case where a job is a copy job and a print job;

FIG. 4B shows a data structure of billing information in a case where a job is a scan job;

FIG. 4C shows a data structure of billing information in a case where a job is a fax job;

FIGS. 5A to 5C each show one example of billing information;

FIG. 6 is a flow chart showing the operation of the MFP 100;

FIG. 7 shows a relationship between the free space of a hard disk and a threshold value; and

FIG. 8 is a table showing a threshold value for each user and category.

### DESCRIPTION OF THE PREFERRED EMBODIMENTS

### Embodiment 1

### 1. General Structure

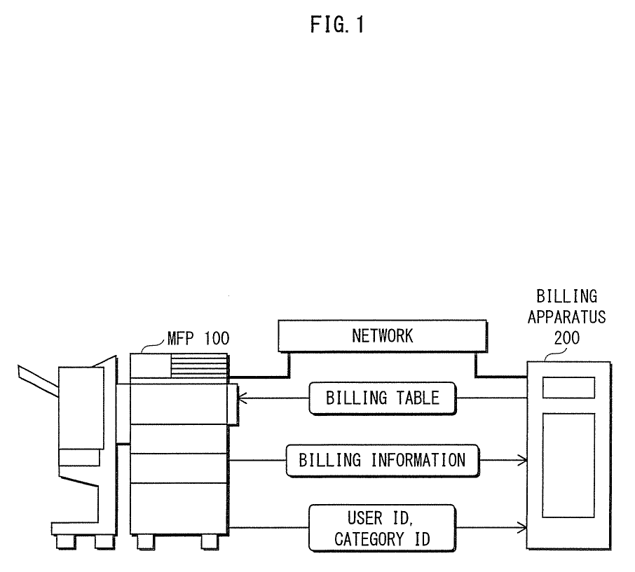

FIG. 1 shows a billing system that includes an image formation apparatus according to one aspect of the present invention. An MFP (Multi Function Peripheral) 100, which is one example of the image formation apparatus, is connected to a billing apparatus 200 via a network.

The MFP 100 receives inputs of a user ID and a category ID from a user, and transmits, to the billing apparatus 200, the user ID and the category ID that have been received, thereby downloading, from the billing apparatus 200, a billing table corresponding to the user ID and the category ID.

Also, based on (i) the free space of a hard disk in the MFP 100, (ii) the size of billing information of a job targeted for execution, and (iii) a predetermined threshold value, the MFP 100 judges whether the job is to be executed. When judging that the job is to be executed, the MFP 100 executes the job (e.g. copying, printing, scanning, faxing, etc.). Then, based on the history of the job, the image formation apparatus generates billing information related to the job while referring to the downloaded billing table, and transmits the generated billing information to the billing apparatus 200.

The billing apparatus 200 stores a plurality of billing tables, each of which corresponds to a user ID and a category ID. The billing apparatus 200 selects a billing table corresponding to a user ID and a category ID that have been transmitted by the MFP 100, and transmits the billing table to the MFP 100. Also, based on the billing information transmitted from the MFP 100, the billing apparatus 200 manages a billing amount related to a job for each of the user IDs and category IDs.

### 2. Structure of MFP

### 2.1. Hardware Structure

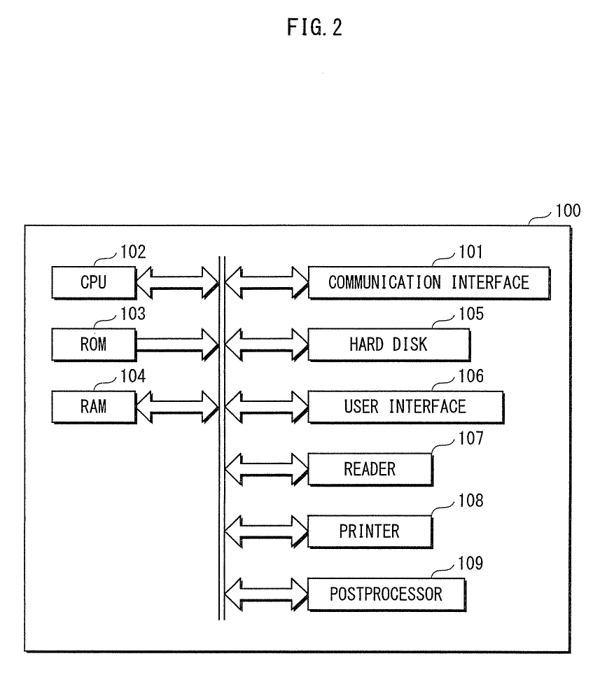

FIG. 2 shows a hardware structure of the MFP 100. As shown in FIG. 2, the MFP 100 includes a communication interface 101, a CPU 102, a ROM 103, a RAM 104, a hard disk 105, a user interface 106, a reader 107, a printer 108, postprocessor (Finishing) 109, etc. that are connected to each other via a bus so that they can communicate with each other.

The communication interface 101 is connected to a network, and transmits a user ID, a category ID, and billing information to the billing apparatus 200, and receives a billing table from the billing apparatus 200.

The ROM 103 stores a threshold value that is used at the time of judgment of whether to give permission to execute the job, and also a control program related to a judgment of a connection state between the MFP 100 and the billing apparatus 200, a control program related to a judgment of whether to give permission to execute a job in a case where the connection state between the MFP 100 and the billing apparatus is a connection failure, and so on.

The RAM 104 is used as a work area of the CPU 102.

The hard disk 105 stores billing information for each of the user IDs and the category IDs.

The CPU 102 judges a connection state between the MFP 100 and the billing apparatus 200. In a case where the connection state has been judged to be a connection failure, the CPU 102 judges, upon receipt of a request of a job such as copying, printing, scanning, or faxing, whether to give permission to execute the job. When judging affirmatively, the CPU 102 executes the job that has been received. Then, the CPU 102 generates billing information related to the executed job, and stores the generated billing information into the hard disk.

The user interface 106 includes an input part and a display part. The input part inputs a condition setting for executing each of the jobs, and various kinds of information such as an address, and the display part displays these kinds of information.

The reader 107 reads an image.

The printer 108 prints the image.

The postprocessor 109 performs a process such as stapling, punching (piercing), paper folding, on a sheet of paper that has been output by the printer 108.

2.2. Functional Structure

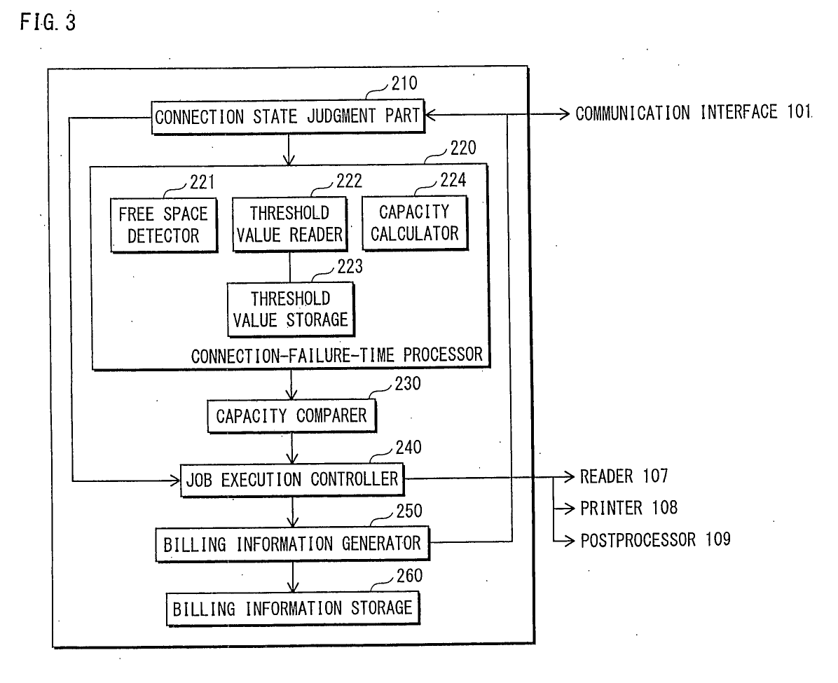

The following describes a function achieved by the CPU 102 operating in accordance with a control program stored in the ROM 103. FIG. 3 is a block diagram showing a functional structure of the MFP 100. As shown in FIG. 3, the MFP 100 includes a connection state judgment part 210, a connection-failure-time processor 220, a capacity comparer 230, a job execution controller 240, a billing information generator 250, and a billing information storage 260.

The connection state judgment part 210 judges a connection state between the MFP 100 and the billing apparatus 200. When judging that the connection between the MFP 100 and the billing apparatus 200 is normal, the connection state judgment part 210 outputs, to the job execution controller 240, a notification that the connection is normal. When judging that the connection between the MFP 100 and the billing apparatus 200 is not normal, the connection state judgment part 210 outputs, to the connection-failure-time processor 220, a notification that the connection is not normal.

The connection-failure-time processor 220 includes a free space detector 221, a threshold value reader 222, a threshold value storage 223, and a capacity calculator 224.

Upon receipt of the notification from the connection state judgment part 210 that the connection is not normal, the free space detector 221 detects the value of the free space of the hard disk 105, and outputs the value of the free space to the capacity comparer 230.

Upon receipt of the notification from the connection state judgment part 210 that the connection is not normal, the threshold value reader 222 reads a threshold value that is stored in the threshold value storage 223, and outputs the threshold value to the capacity comparer 230.

The threshold value storage 223 pre-stores a threshold value used for a judgment of whether to give permission to execute a job.

Upon receipt of a notification from the connection state judgment part 210 that the connection is not normal, the capacity calculation unit 224 calculates the size of billing information of a job targeted for execution, and outputs the calculated size to the capacity comparer 230.

The capacity comparer 230 compares the size of the free space of the hard disk 105, the threshold, and the size of billing information of the job targeted for execution that have been input from the connection-failure-time processor 220, and outputs a comparison result thereof to the job execution controller 240.

The job execution controller 240 controls the reader 107, the printer 108, and the post processor 109, based on the comparison result input from the capacity comparer 230.

Also, upon receipt of the notification from the connection state judgment part 210 that the connection is normal, the job execution controller 240 controls the reader 107, the printer 108, and the post processor 109, so that a job is executed.

Furthermore, the job execution controller 240 outputs, to the billing information generator 250, the history of the job that has been executed.

The billing information generator 250 generates billing information, based on the history of the job that has been input from the job execution controller 240, and a billing table that has been acquired in advance. Then, the billing information generator 250 outputs the generated billing information to the billing information storage 260, and also transmits the generated billing information to the billing apparatus 200 via the communication interface 101.

The billing information storage 260 stores the billing information that has been input from the billing information generator 250 into the hard disk 105.

### 3. Billing Information

3.1. Data Structure of Billing Information

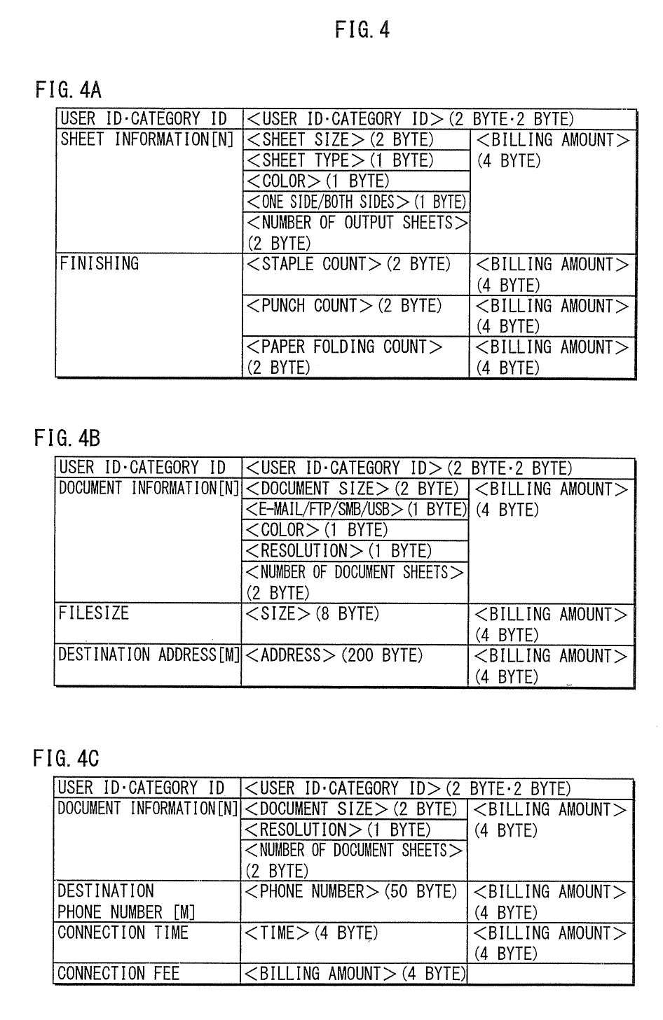

The following describes the data structure of billing information. The billing information is information in which job history information related to a job is associated with the billing amount of the job. The billing information has three different types of data structures depending on the kind of a job executed by the MFP 100. FIG. 4A shows a data structure of the billing information in a case where the job is a copy job and a print job, FIG. 4B shows a data structure of the billing information in a case where the job is a scan job, and FIG. 4C shows a data structure of the billing information in a case where the job is a fax job.

As shown in FIG. 4A, in a case where the job is a copy job and a print job, the billing information includes fields for a user ID and category ID, sheet information, and Finishing.

The sheet information includes fields for a sheet size, a sheet type, color, one side/both sides, the number of output sheets, and a billing amount. There are [N] pieces of sheet information, [N] being the number of pieces of sheet information used for the job.

Finishing includes fields for a Staple count, a Punch count, a paper folding count, and billing amounts corresponding to the respective counts.

As shown in FIG. 4B, in a case where the job is a scan job, the billing information includes fields for a user ID and category ID, document information, FileSize, and a destination Address.

The document information includes fields for a document size, the output form (E-mail/FTP/SMB/USB) of image data, color, resolution, the number of document sheets, and a billing amount. There are [N] pieces of document information, [N] being the number of pieces of document information related to documents used for the job. FileSize includes fields for Size and a billing amount. The destination Address includes fields for Address and a billing amount. There are [M] destination Addresses, [M] being the number of destination Addresses used for the job.

As shown in FIG. 4C, in a case where the job is a fax job, the billing information includes fields for a user ID and category ID, document information, a destination phone number, connection time, and a connection fee. The document information includes fields for a document size, resolution, the number of document sheets, and a billing amount. There are [N] pieces of document information, [N] being the number of pieces of document information related to documents used for the job. The destination phone number includes fields for a phone number and a billing amount. There are [M] destination phone numbers, [M] being the number of destination phone numbers used for the job. The connection time includes fields for time and a billing amount, and indicates a fee charged according to the connection duration. The connection fee indicates a fee that is charged by the connection being established.

3.2. Calculation Method of Size of Billing Information

The following describes a method for calculating the size of the billing information of a job targeted for execution. As shown in FIGS. 4A to 4C, each item of billing information is assigned a predetermined number of bytes. Therefore, it is possible to calculate the size of the billing information of a job targeted for execution, by determining the sheet size, the number of sheets, etc. that are used for the job, and adding the number of bytes for each of the items that constitute the billing information of the job.

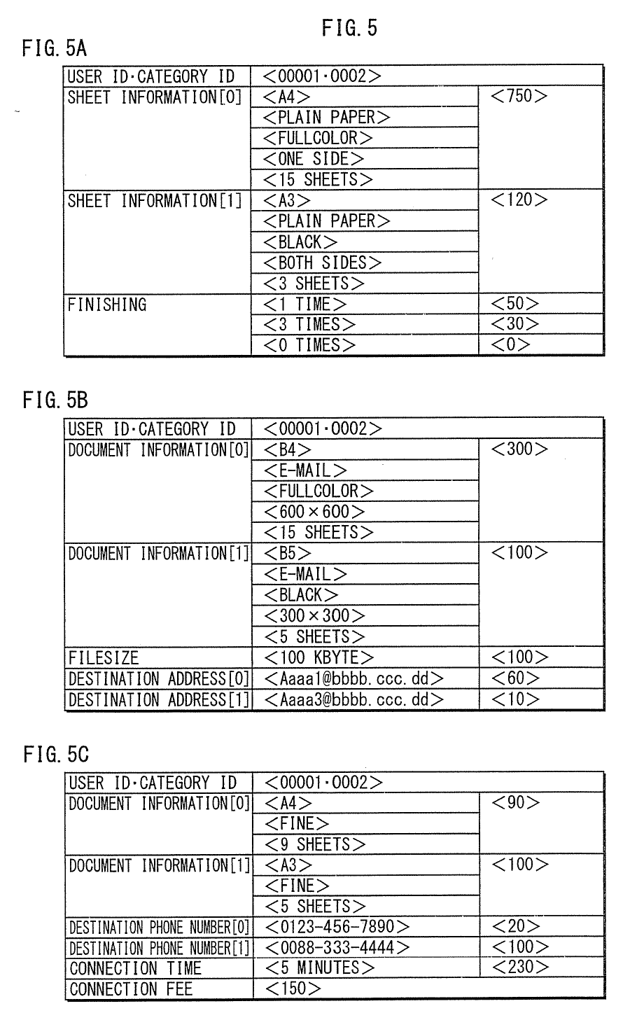

FIGS. 5A to 5C each show one example of the billing information. FIG. 5A shows the billing information in a case where the job is a copy job and a print job. In this case, the total size of the billing information is 44 Byte, wherein the size of the user ID and category ID is 4 Byte, the size of the sheet information [0] is 11 Byte, the size of the sheet information [1] is 11 Byte, and the size of Finishing is 18 Byte.

FIG. 5B shows the billing information in a case where the job is a scan job. In this case, the total size of the billing information is 446 Byte, wherein the size of the user ID and category ID is 4 Byte, the size of the document information [0] is 11 Byte, the size of the document information [1] is 11 Byte, the size of FileSize is 12 Byte, the size of the destination Address [0] is 204 Byte, and the size of the destination Address [1] is 204 Byte.

FIG. 5C shows the billing information in a case where the job is a fax job. In this case, the total size of the billing information is 142 Byte, wherein the size of the user ID and the category ID is 4 Byte, the size of the document information [0] is 9 Byte, the size of the document information [1] is 9 Byte, the size of the destination phone number [0] is 54 Byte, the size of the destination phone number [1] is 54 Byte, the size of the connection time is 8 Byte, and the size of the connection fee is 4 Byte.

In a copy job, the size of the billing information increases if, for example, more than one type of sheet is used. In a scan job and a fax job, the size of billing information increases if, for example, there are a large number of destinations.

### 4. Operation of MFP

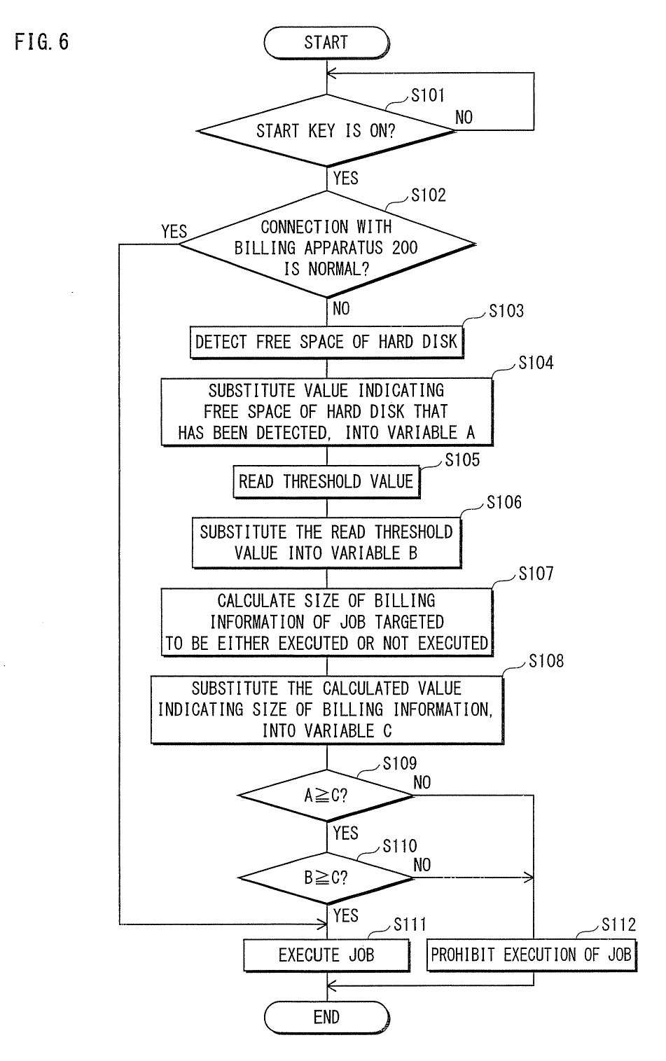

The following describes the operation of the MFP 100. FIG. 6 is a flow chart showing the operation of the MFP 100. When the start key of the MFP 100 is turned on (Yes in step S101), the MFP 100 judges whether the connection with the billing apparatus 200 is normal (step S102). This judgment is performed by the MFP 100 transmitting a polling signal and judging whether the MFP 100 has received a response signal (ACK) from the billing apparatus 200.

When judging that the connection with the billing apparatus 200 is not normal (No in step S102), the MFP 100 detects the free space of the hard disk (step S103), and substitutes, into a variable A, a value indicating the free space of the hard disk that has been detected (step S104).

Then, the MFP 100 reads a threshold value (step S105) and substitutes the threshold value into a variable B (step S106) This threshold value is a value that is set so as to store billing information more reliably. Subsequently, the MFP 100 calculates the size of the billing information of a job targeted for execution (step S107), and substitutes, into a variable C, a value indicating the size of the billing information that has been calculated (step S108).

Then, the MFP 100 judges whether the variable A is greater than or equal to the variable C (step S109). If the variable C is greater than the variable A (No in step S109), the MFP 100 prohibits the execution of the job (step S112). Note that, since the start key is already turned on, the prohibition of the execution of the job described above means the cancellation of the job.

In a case where the variable A is greater than or equal to the variable C (Yes in step S109), the MFP 100 judges whether the variable B is greater than or equal to the variable C (step S110). This step is performed in consideration of a case where the billing information of a job targeted for execution takes too much free space of the hard disk although it is possible to store the billing information. In this case, if the job is permitted to be executed, the used space of the hard disk may come close to the maximum capacity of a portion of the hard disk that is allocated for the billing information to be stored, resulting in other users not being able to use the MFP 100.

Therefore, as shown in FIG. 6, when the variable C is greater than or equal to the variable B (No in step S110), the job execution control unit 240 of the MFP 100 prohibits the execution of the job (step S112).

When the variable B is greater than or equal to the variable C in step S110 (Yes in step S110), and the connection with the billing apparatus 200 is judged to be normal (Yes in step S102), the MFP 100 executes the job (step S111).

As described above, according to the present embodiment, instead of executing a job immediately after the start key is turned on, the MFP 100 first compares the size of the free space of the hard disk with the size of the billing information of a job targeted for execution. Then, if the size of the billing information of the job is larger than the size of the free space of the hard disk, the MFP 100 prohibits the execution of the job. This prevents a situation where the billing information of a job cannot be stored even though the job can be executed.

Furthermore, even in a case where the size of the free space of the hard disk is greater than or equal to the size of the billing information of a job targeted for execution, the MFP 100 compares the size of the billing information of the job with the threshold value, and prohibits the execution of the job when the size of the billing information of the job is larger than the threshold value. This makes it possible to prevent the execution of a job whose billing information takes too much free space in the hard disk, resulting in the usability of the MFP 100 being improved.

### (Modification)

Although an image formation apparatus according to one embodiment of the present invention has been described based on the above-described embodiment, the present invention is not limited to such.

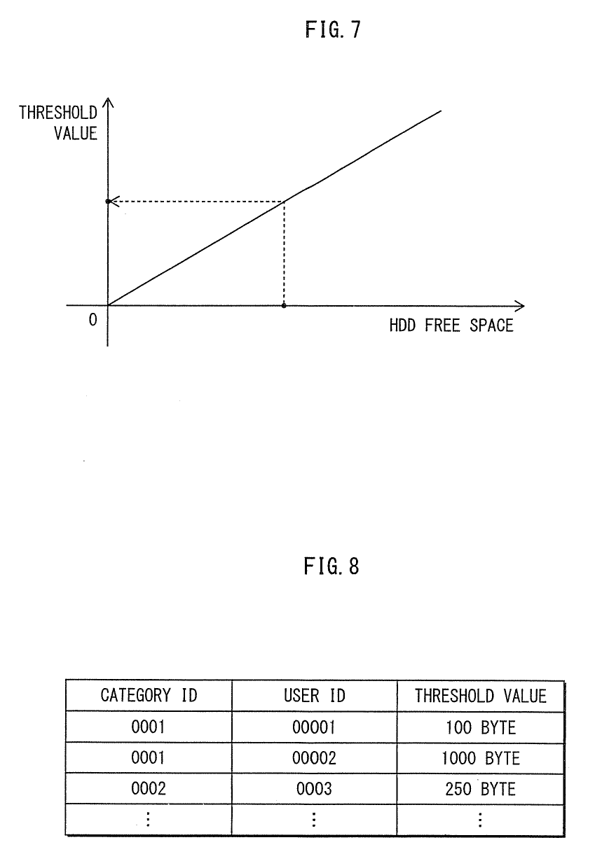

(1) In the above-described embodiment, the threshold value is a fixed value. However, the threshold value may be a value that varies in accordance with the free space of the hard disk. FIG. 7 shows a relationship between the free space of the hard disk and the threshold value. In this case, the larger the free space of the hard disk is, the larger the threshold value is. When the threshold value is large, the execution of a job is less likely to be prohibited, resulting in the usability of the image formation apparatus being improved as compared to a case where the threshold value is a fixed value.

As described above, the judgment of whether to give permission to execute a job can be flexibly performed since the threshold value varies in accordance with the free space of the hard disk.

(2) Also, a threshold value may be set for each of the users and/or the categories. In this case, the image formation apparatus may further include a receiver that receives, from a user, the input of a user identifier and/or a category identifier, and the capacity comparer 230 may perform the comparison with use of a threshold value corresponding to the user identifier and/or the category identifier that have been received by the receiver. FIG. 8 is a table showing a threshold value for each of the users and categories. Since a threshold value is set for each of the users and categories, the resource of the storage can be appropriately allocated to a desired user and category by, for example, setting a threshold value low for a user and his/her category that frequently executes a job whose billing information takes a large amount of free space of the storage. This further improves the usability of the image formation apparatus.
(3) In the above-described embodiment, a threshold value is set in the MFP 100. However, the threshold value may be set in the billing apparatus 200 and transmitted to the MFP 100. This is because the billing apparatus 200 generally includes a large liquid crystal display device and such, and therefore has better operability than the MFP 100.

The present invention may be any combination of the above-described embodiment and modifications.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An image formation apparatus for performing a billing process, by generating billing information of a job after executing the job and transmitting the billing information to a billing apparatus when a connection to the billing apparatus is normal, the image formation apparatus comprising:
a storage for storing therein billing information;
a judgment part operable to judge whether the connection to the billing apparatus is normal; and
a job execution controller operable to compare a size of billing information of a target job that is targeted for execution with a size of free space of the storage in a case where the connection is judged to be a connection failure, and prohibit the execution of the target job when the size of the billing information of the target job is larger than the size of the free space of the storage.

2. The image formation apparatus of claim 1 wherein
the job execution controller further compares the size of the billing information of the target job with a predetermined threshold value when the size of the free space of the storage is larger than or equal to the size of the billing information of the target job, and prohibits the execution of the target job when the size of the billing information of the target job is larger than the predetermined threshold value.

3. The image formation apparatus of claim 1 further comprising:
a receiver operable to receive a user identifier input by a user; and
a threshold value table showing user identifiers and predetermined threshold values in one-to-one correspondence, wherein
the job execution controller further compares the size of the billing information of the target job with one of the predetermined threshold values that corresponds to the user identifier received by the receiver when the size of the free space of the storage is larger than or equal to the size of the billing information of the target job, and prohibits the execution of the target job when the size of the billing information of the target job is larger than the one of the predetermined threshold values.

4. The image formation apparatus of claim 2 wherein
the predetermined threshold value varies in accordance with the size of the free space of the storage, and
a larger the size of the free space of the storage is a larger the predetermined threshold value is.

5. The image formation apparatus of claim 2 further comprising
a receiver operable to receive the predetermined threshold value from an external device.

6. The image formation apparatus of claim 1 wherein
the job execution controller executes the target job when the size of the free space of the storage is larger than or equal to the size of the billing information of the target job.

7. The image formation apparatus of claim 1 wherein
the billing information of the target job includes a plurality of items, and
the size of the billing information of the target job is calculated by adding storage capacities, each of which is allocated to the respective items of the billing information of the target job.

8. A method for prohibiting execution of a target job that is targeted for execution, comprising the steps of:
judging whether a connection to a billing apparatus is normal; and
comparing a size of billing information of the target job with a size of free space of a storage that is for storing billing information in a case where the connection is judged to be a connection failure, and prohibit the execution of the target job when the size of the billing information of the target job is larger than the size of the free space of the storage.

9. A recording medium for storing a program that causes a computer to perform a process of prohibiting execution of a target job that is targeted for the execution, wherein
the program comprises the steps of:
judging whether a connection to a billing apparatus is normal; and
comparing a size of billing information of the target job with a size of free space of a storage that is for storing billing information in a case where the connection is judged to be a connection failure, and prohibit the execution of the target job when the size of the billing information of the target job is larger than the size of the free space of the storage.
